(19) United States
(12) Patent Application Publication
(10) Pub. No.: US 2012/0290643 A1
(43) Pub. Date: Nov. 15, 2012

(54) CLIENT-SERVER SYSTEM

(76) Inventors: Frederic Fok Ah Chuen, Berkshire (GB); Benoit Lecroart, Berkshire (GB)

(21) Appl. No.: 13/519,861

(22) PCT Filed: Nov. 5, 2010
(86) PCT No.: PCT/JP2010/070162

§ 371 Date: Jun. 28, 2012

(30) Foreign Application Priority Data
Jan. 20, 2010 (GB) 1000874.6

(51) Int. Cl. G06F 15/16

(52) U.S. Cl. 709/203

(57) ABSTRACT

A client-server system is described in which a server that is to host a virtual machine is selected based on the location of the client device. The virtual machine is configured on the selected server before it is requested by the client device. In this way, the client device can use the virtual machine with minimal delay and latency associated with using virtual machines over wide area networks.

### TECHNICAL FIELD

The present invention relates to a client-server system and method and to components thereof. The invention has particular relevance to server systems that provide virtual machines for different client devices.

### BACKGROUND ART

Virtualisation systems are known in which one or more central server(s) is/are responsible for running virtual machines on behalf of a number of client devices in a client-server network architecture. The virtual machine running on one of the servers handles most of the processing for a client device, with user input events being reported by the client device to the virtual machine and with associated outputs generated by the virtual machine being sent back to the client device for output to the user. Accordingly, a device with only minimal processing power may be used as the thin client, although devices with greater processing power may be configured to act as a thin client when it is practicable to do so.

With the increasing popularity of mobile computational and communication devices and in particular mobile (cellular) telephones it is now commonplace for individuals to carry their mobile devices with them most of the time. These devices are increasingly flexible in terms of their ability to communicate with one another and other computer devices (PCs, laptops, servers etc.) using a variety of short and/or wide range wireless and wired technologies.

Nowadays thin client and virtualization technologies allow dynamic configuration and start-up of a virtualized environment (e.g. a PC image running on a virtual machine) for a user device based on its profile thereby allowing remote access to a desktop. VMWare Inc and Citrix Systems Inc are two companies that offer such virtualisation systems. The profile can include a group to which the user belongs, his application preferences, the processing power required for a given application, or the requested CPU (if more than one is available) etc. At initial connection establishment the user device accesses a gateway (that will be referred to in the following description as a Broker Gateway) responsible to direct the user device to a given server hosting the virtual machine by analyzing profile and load balancing information. Such a broker gateway is common to access a remote application or a remote operating system virtualized on a server. The server can be selected based on user profile information and other information such as server availability, network load, available CPU, etc. a virtual machine needs also to be prepared before the user device can access it.

This technology works well in places where the user's device is located rather close to the server hosting the virtualized environment. However, when the user's device is located quite remote from the server hosting the virtualised environment, the system does not work as well because of delays and interaction latencies caused by the distance between the server and the, user's device. To alleviate this problem some scaling solutions consist in monitoring the resources and server/network load so as to dynamically direct the user to the most suitable server (or virtual machine).

When using a mobile device the user is likely to connect from a certain place and from another place at a different point in time. Hence when the user disconnects and reconnects to their virtual machine after they have moved to a new geographical area (and hence through another access network), it is best to reduce the network path cost by selecting the closest server. Solutions can use geographical position of the user device for the server selection in addition to load balancing techniques. The publication entitled “Seamless Live Integration of Virtual Machines over the MAN/WAN”, from Franco Travostino and al., Elsevier Future Generation Computer Systems 2006, the content of which is incorporated herein by reference, describes in more detail techniques for the live migration of virtual machines over a WAN by establishing IP tunnels.

In the case where the user's virtual machine does not exist or is not already prepared, the user has to wait for the virtual machine to be prepared during the connection establishment. In the case where the user virtual machine exists, it might be necessary to migrate it to a new selected server. Although the downtime caused by live migration can be rather small, there is still a time required to migrate the virtual machine on the selected new server.

### SUMMARY

The present invention was made in an attempt to optimize the connection establishment so that in an ideal embodiment, the user is provided with immediate availability of the virtualized environment. In one embodiment, the invention uses location information of the user's device to anticipate the configuration and selection of an appropriate virtualized environment on distributed server farms (country to country, or within a country, or between offices of a building such as distributed conference rooms etc). In a further embodiment the connection parameters of the selected virtualized environment are sent to and stored on the mobile device and synchronized with those stored at the broker gateway in order to accelerate the connection establishment. This predicted knowledge of the virtual machine connection parameters avoids the user from having to know the required connection details and optimizes the connection establishment to the virtual machine without necessarily going through the broker gateway.

According to one aspect, a client server system is provided comprising: a plurality of servers distributed in a plurality of different locations, each for hosting virtual machines to be used by client devices; a client device operable to use a virtual machine hosted on a selected server; and a broker gateway operable to select the server that will host the virtual machine to be used by the client device; wherein the broker gateway is operable to select the server to host the virtual machine based on a current location of the client device; and is operable to request establishment of a virtual machine for use by the client device on the selected server prior to the client device making a request to connect to the virtual machine.

According to another aspect, a method is provided for anticipating the preparation of at least one virtual machine for a user, wherein the anticipating is based on a current location of the client device, wherein the virtual machine is hosted on a server selected by the broker gateway, and wherein the preparation is done by a broker gateway prior to the client device making a request to connect to the virtual machine.

According to a further aspect, the method comprises a step of storing and keeping virtual machine connection parameters sent by the broker gateway to the client device up to date. Advantageously, the connection parameters are used by the client device at the next connection attempt to a virtual machine, without necessarily requiring an access to the broker gateway.

According to another aspect, the invention provides a broker gateway that selects a server that will host a virtual machine to be used by a client device; wherein the broker gateway is operable to select a server to host the virtual machine based on the current location of the client device; and is operable to establish a virtual machine for use by the client device on the selected server prior o the client device making a request to connect to the virtual machine.

In one embodiment, the broker gateway stores data defining the location of a plurality of servers and compares the location data for the client device with the stored server location data and selects the server based on the comparison results. The broker gateway may select a server near the current location of the client device for hosting the virtual machine for the client device.

In a preferred embodiment, the location information for the client device can be geographical coordinates, cellular information (Mobile Country Code, Mobile Network Code), Network Access Point Name (WiFi AP name) and/or an estimated distance from a Network Access Point, etc.

In another embodiment, the broker gateway comprises user profile data and sends the user profile data for the selected server for establishing the virtual machine for the client device. The user profile data may be sent directly to the selected server or via another broker gateway.

In another embodiment the broker gateway stores the data defining the selected server for a given location data and synchronizes it with the client device. As such the broker gateway also sends the client device parameters that the client device can use to connect to the virtual machine hosted on the selected server. The parameters may include the network address of the virtual machine or of the selected server.

The present invention also provides a client device that is operable to communicate with a server and a broker gateway, wherein the client device receives parameters for a virtual machine from the broker gateway and requests a connection to the virtual machine hosted by the server and wherein the client device obtains the parameters for the virtual machine prior to requesting a connection to the virtual machine.

In one embodiment, the client device comprises a synchronization module operable to keep virtual machine connection parameters up to date with the broker gateway, and wherein the connection parameters are updated by the broker gateway based on a current location of the user.

In a preferred embodiment the client device uses the stored virtual machine connection parameters for connecting to a virtual machine. If the connection fails the client device makes a request to the broker gateway in order to connect to a virtual machine and get the virtual machine connection parameters prior to connecting to the virtual machine. Advantageously the connection details can be stored and managed in a secure module (an encrypted memory area in the mobile device, in the Universal Subscriber Identity Module, or other secure element).

The present invention also provides a server that communicates with a broker gateway and a client device, the server being operable to setup a virtual machine for use by the client device in response to a request received from the broker gateway and providing a connection between the virtual machine and the client device in response to a request for a connection received from the client device; and wherein the server is configured to setup the virtual machine for the client device prior to receiving the connection request from the client device.

The invention also provides, for all methods disclosed, corresponding computer programs or computer program products for execution on corresponding user communications devices or network communications devices. The invention also provides user communications devices and network communications devices configured or operable to implement the methods and components thereof and methods of updating these.

### BRIEF DESCRIPTION OF THE DRAWINGS

These and various other aspects of the invention will become apparent, from the following detailed description of embodiments which is given by way of example only and which are described with reference to the accompanying drawings in which:

FIG. 1 schematically illustrates a client-server virtualisation system in which a mobile user device includes a thin client module that works with virtualisation software running on a server farm, and illustrating a change of server farm when the user device is moved from a France to Japan;

FIG. 2 schematically illustrates a communication system having a number of client devices, broker gateways and server farms that communicate over a communications network;

FIG. 3 is a block diagram illustrating the main components of a server farm shown in FIG. 2;

FIG. 4 is a block diagram illustrating the main components of a broker gateway shown in FIG. 2;

FIG. 5 is a block diagram illustrating the main components of a client device shown in FIG. 2;

FIG. 6 illustrates an embodiment in which different users connect to different server farms based on an access point/router to which they connect to a home broker gateway;

FIG. 7 is a signal flow chart illustrating the communications that are made between the devices shown in FIG. 6;

FIG. 8 illustrates the network connections that are made over an internal network and an external network with the embodiment shown in FIG. 6;

FIG. 9 is a flow chart illustrating the way in which a broker gateway can implement policy control in deciding on a server to host a virtual machine;

FIG. 10 is a signal flow chart illustrating the communications that are made in an alternative embodiment;

FIG. 11 is a flow chart illustrating the way in which a broker gateway can implement policy control in deciding on a server to host a virtual machine and illustrating the way in which the broker gateway synchronises the VM parameters with the client device; and

FIG. 12 illustrates the way in which the client device can use the VM parameters to access its virtual machine without necessarily contacting the broker gateway.

### EXEMPLARY EMBODIMENT

### Overview

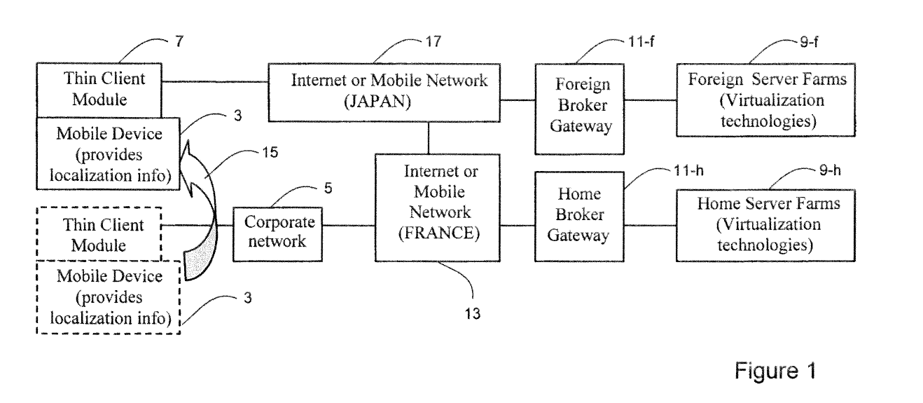

FIG. 1 schematically illustrates a client server system according to one embodiment of the present invention. As shown, the system includes a user mobile device 3 (for example a mobile or cellular telephone) that can communicate with a corporate network 5, for example when the user is at work. The mobile device 3 includes a thin client module 7 that, when the mobile device is in the vicinity of the corporate network, can connect to a home server farms 9-h via a home broker gateway 11 and the Internet or mobile network 13 in the home country (in this example France). The home server farms 9-h provide virtualisation technologies for the thin client module 7. This means that the home server farms 9 run software for the mobile device 3 and provide: i) output data to the thin client module 7 which the thin client module uses to output information to the user; and ii) input data to the thin client module 7 which the thin client module uses to control the responses returned to the virtual machine being hosted on the server farms 9. The way that such virtualisation technologies operate are well known to those skilled in the art and will not he described in further detail here.

As represented by the arrow 15, when the user mobile device 3 moves away from the corporate network, in this example to Japan, the mobile device 3 can connect to the home broker gateway 11-h and the home server farms 9-h through the Internet or the mobile network 17 in Japan. In this situation, the user will experience the above described delays and latencies caused by the large separation between the user's mobile device 3 and the home server farms 9-h. Therefore, in this embodiment, information about the current location of the user's mobile device 3 is provided to the home broker gateway 11-h, which uses the location information to prepare the virtualised environment for the user before the user requests access to the virtualised environment. This preparation can be the transfer of an existing virtual machine of the user to a foreign server farms 9-f located near the user's mobile device 3; or the creation of a new virtual machine on the foreign server farms 9-f based on user profile information available to the home broker gateway 11-h. Subsequently, when the user uses their mobile device to initiate, or continue interacting with, the virtual machine, it does so with the foreign server farms 9-f directly or through the foreign broker gateway 11-f. In this way, the system can provide immediate availability of the virtual machine. Advantageously the system also avoids the above described delays and latency problems.

In a preferred embodiment, the location information is also coupled with policy rules in order to ensure an optimal preparation of the virtualised environment. For instance a policy rule may be defined such that the virtualised environment can be moved only between specific geographical areas (e.g. between FRANCE and JAPAN). Therefore if the user is in transit in London and even if there is a local server farm 9 available, the virtualised environment will not be prepared. Alternatively, within a big building, a service provider may have multiple floors and virtual machine environments requiring different configurations for each conference room and for each user. Depending on the location of the user (which desk, which wireless access point to which he is attached, etc . . . ) a virtualized environment can be setup automatically prior to the user connection setup, based on the service policy rules. Therefore instead of using central server farms, the virtualized environment can he setup migrated to distribute the network load while anticipating all user positions. In this way, if multiple users are located in the same room, their virtual machines can be setup in advance on separate servers to avoid an anticipated bottleneck that might occur at start up if they were all setup on the same server.

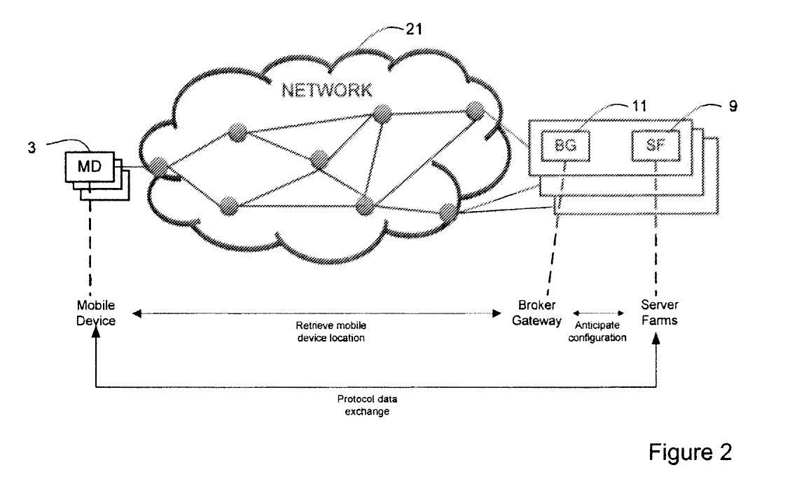

Although FIG. 1 shows a single mobile user device 3 and home and foreign server farms 9, in practice there may be a multitude of user devices 3 and server farms 9 and broker gateways 11, as illustrated in FIG. 2. As shown in FIG. 2, the mobile devices 3 communicate with the broker gateways 1 and the server farms 9 over a network 21 (which may include parts of the Internet and/or the mobile telephone network). The broker gateways 11 communicate either with the mobile devices 3 or with the network 21 to determine the locations of the mobile devices and based on this anticipate the required configuration of the virtual machines hosted by the server farms 9. The server farms 9 and the mobile devices 3 then communicate with each other to provide the appropriately configured virtualised applications on the mobile devices 3.

### Server Farms

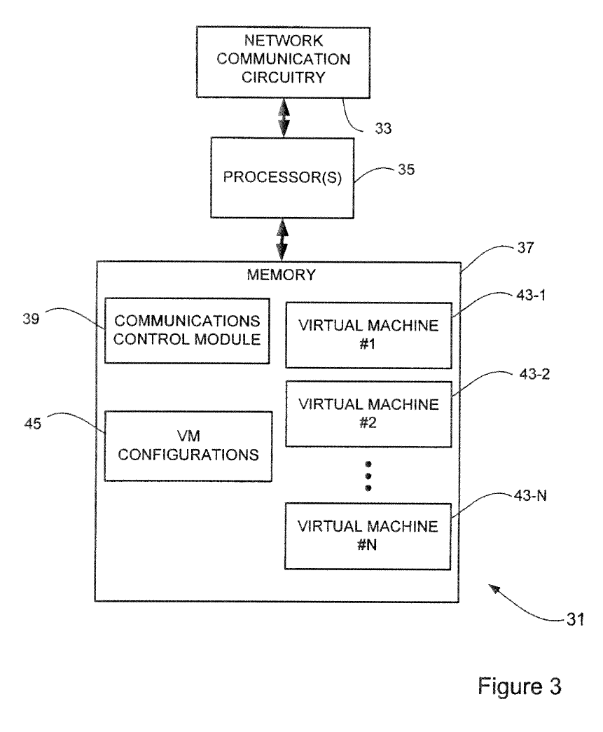

A server farm 9 is basically a collection of computer servers. FIG. 3 illustrates the main components of one of the servers 31 that forms part of the server farm 9. As shown, the server 31 includes network communication circuitry 33 to allow the server to communicate with the broker gateway 11 or with the mobile device 3 via the network 21. The server 31 also includes one or more processors 35 that control the communications using the network communications circuitry 33 in accordance with software stored in memory 37. As shown, the software in memory 37 includes a communications control module for controlling the communications with the broker gateway 11 and with the mobile devices 3. The software also includes software defining a number of the virtual machines 43-1 to 43-N. The virtual machines 43 are configured based on VM configuration information 43 received from the broker gateway 11. When the server receives new configuration information from the broker gateway, the server configures the virtual machine 43 so that it is ready to be used when the mobile device 3 requests a connection to the virtual machine.

### Broker Gateway

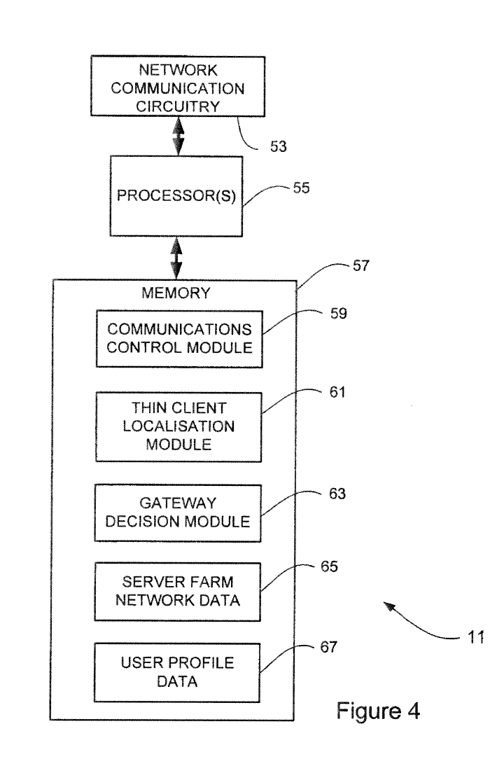

The broker gateways 11 are basically network nodes (such as servers, routers or switches). FIG. 4 illustrates in more detail the main components of one of the broker gateways 11 used in this embodiment. As shown, the broker gateway 11 includes network communication circuitry 53 that allows it to communicate with the mobile devices 3 and the server farms 9. The broker gateway 11 also includes one or more processors 55 that control the communications using the network communications circuitry 53 in accordance with software stored in memory 57. As shown. the software in memory 57 includes a communications control module 59 for controlling the communications with the broker gateway 11 and with the mobile devices 3. The software also includes a thin client location module 61 for obtaining location information for the mobile device 3. This location information is used by a gateway decision module 63 to select the broker gateway 11 and server farm 9 to be used by the mobile device 3 given its current location. This decision is also made by the gateway decision module 63 based on knowledge of the geographical location of the different server farms 9, which information is maintained in server farm network data 65. The broker gateway 11 also stores user profile data 67 for each user device and the gateway device 11 sends the user profile data for a user to the selected server for establishing the virtual machine on the selected server.

### Mobile Device

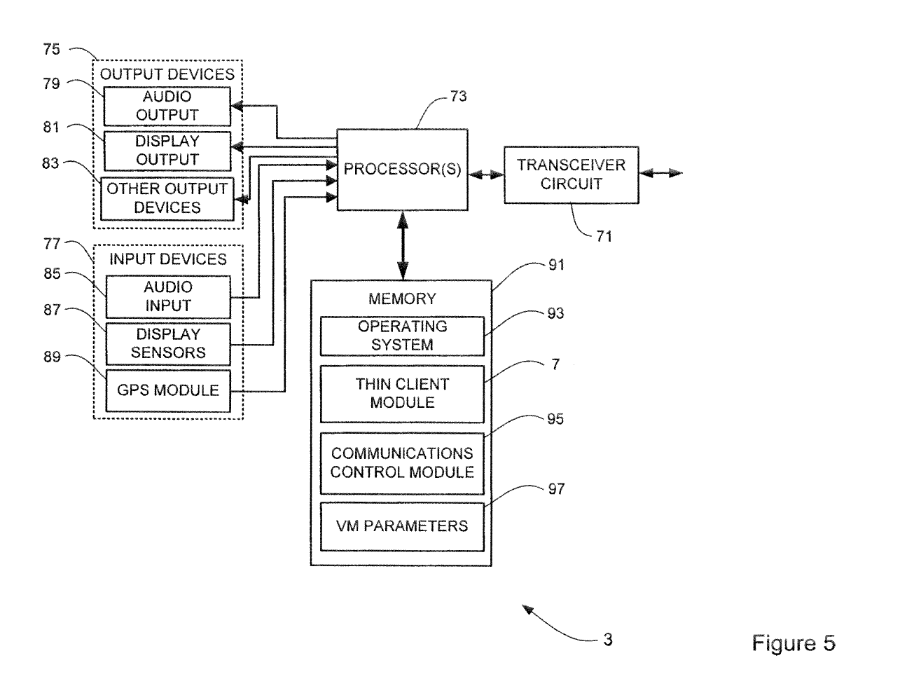

The user mobile device 3 may be a hand held Personal Digital Assistant (PDA), a phone, a laptop computer or the like. FIG. 5 illustrates the main components of the mobile device 3 used in this embodiment. As seen in FIG. 5, the mobile device 3 includes a transceiver circuit 71 which is operable to transmit signals to and to receive signals from a broker gateway 11 or server farm 9 via a mobile telephone network or a computer network. The mobile device 3 also includes one or more processors 73 which control the operation of the mobile device 3 and which are connected to the transceiver circuit 71, to a number of output devices 75, and to a number of input devices 77. The output devices 75 may include an audio output device 79 having a loudspeaker, a display output device 81 and other output devices 83 (such as a vibrating device or a printer). The input devices 77 include an audio input device 85 (a microphone), display sensors 87 for a touch sensitive screen and a GPS module 89 for providing location data for the current geographical location of the mobile device 3.

The or each processor 73 operates in accordance with software instructions stored within memory 91. As shown, these software instructions include, amongst other things, an operating system 93, the thin client module 7 and a communications control module 95. The memory 91 also stores virtual machine (VM) parameters 97 that define the virtual machine that the mobile device has been programmed to use. The VM parameters 97 also include (at least on a temporary basis) the network address for the server farm 9 that is hosting the virtual machine 43 at any given time. This network address is provided to the mobile device 3 by the home broker gateway 11 in response to the home broker gateway 11 obtaining the location of the mobile device 3. In this embodiment, the mobile device 3 provides this location data to the home gateway 11 by sending GPS data input from the GPS module 89. However, as those skilled in the art will appreciate, other techniques can be used to provide location data to the home gateway 11-h. For example, where the mobile device 3 connects to a network at an access point, the network address of the access point (or base station) or the sub-network in which the access point is located can be used to provide location information to the home broker gateway 11-h. The home broker gateway 11 may also obtain location information from the mobile network to which the mobile device is connected. This location information may be the country code, the mobile network code or the cell ID of the mobile network in which the mobile device 3 is currently registered.

### Operation

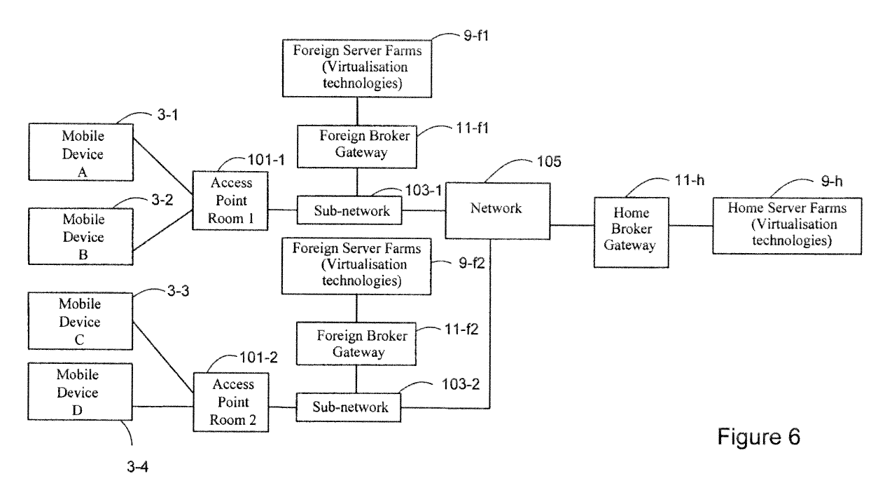

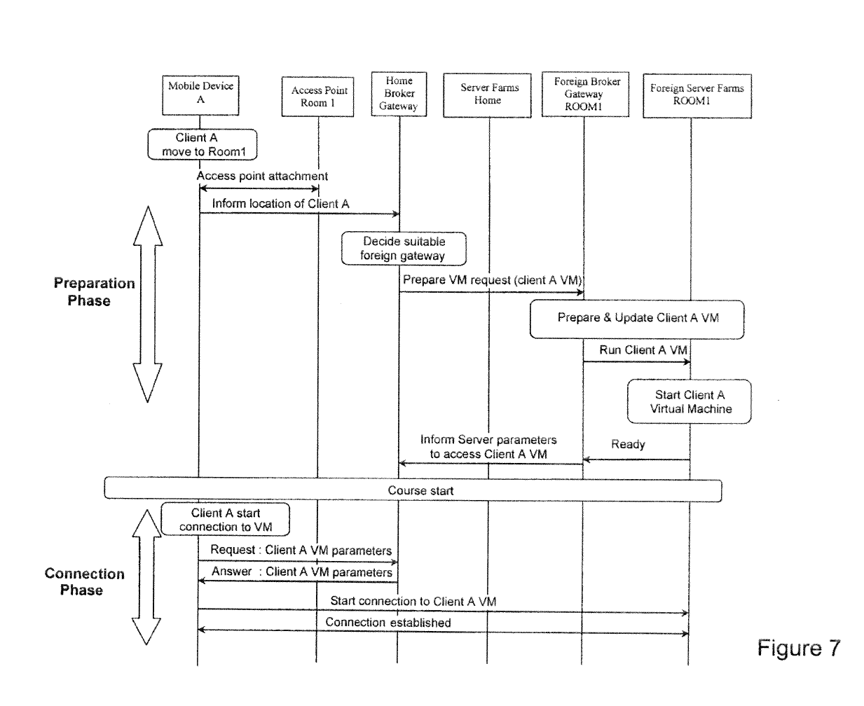

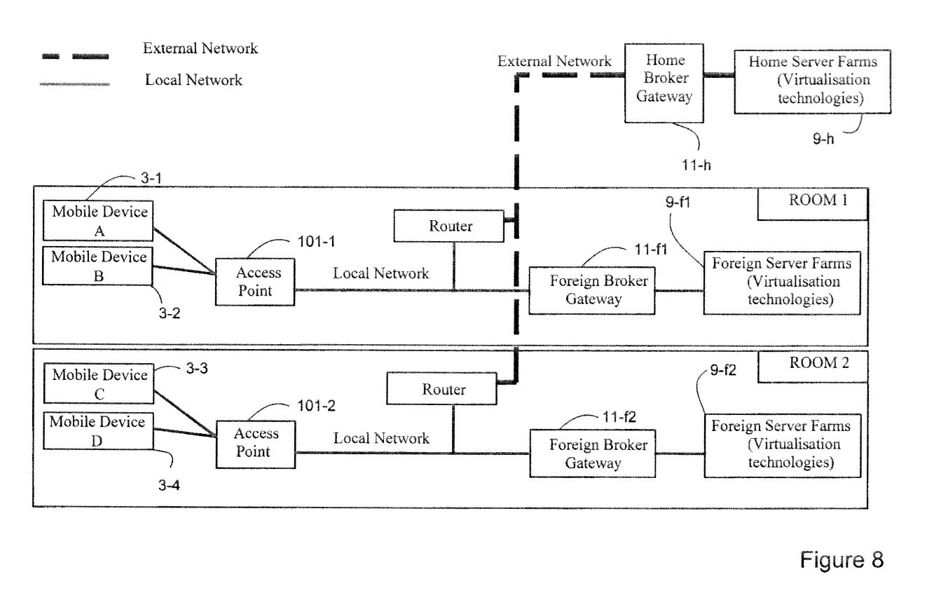

The operation of this embodiment will now be described with reference to FIGS. 6 to 8 for an example scenario in which a user wishes to take part in a new training session and registers to the training session via a website. FIG. 6 is a block diagram illustrating the main components used in the scenario, FIG. 7 is a signal flow diagram illustrating the communications that take place between the devices shown in FIG. 6 and FIG. 8 illustrates the communications that take place over an internal network and those that require communications over an external network.

When registering for the training session, the user will fill in some details such as the level of complexity, the level of their knowledge, their interest, type of expected exercises, type of training etc. The user may use their mobile device 3 to perform this registration process. Upon registration the user will be provided with a participation identifier that is stored in the VM parameters data 97. The registration information provided by the user is stored in the user profile data 67 stored in the home broker gateway 11-h in association with the user's participation identifier. Some time later (for example a day or a week later), the user arrives at a conference room, where the user establishes a connection between their mobile device 3 and an access point 101 of the local computer sub-network 103. This connection may be made, for example, by the user touching their mobile device against the access point 101 such that wireless connection parameters can be exchanged using a short range wireless communications technology (such as NFC). Multiple mobile devices 3 can connect to the same access point and different users (perhaps in different rooms or buildings or countries etc) can connect via different access points 101. This is illustrated in FIG. 6, which shows four mobile devices 3-1 to 3-4, with mobile devices 3-1 and 3-2 (that are associated with users A and B) connecting to access point 101-1 in Room 1 and with mobile devices 3-3 and 3-4 (that are associated with users C and D) connecting to access point 101-2 in Room 2.

Once a mobile device 3 has attached to the access point 101, the thin client module 7 in the mobile device 3 contacts the home broker gateway 11-h (the address of which is stored in the memory 91 of the mobile device 3) via the wide area network 105 (e.g. the Internet) and provides the user's participation identifier, thereby informing the home broker gateway 11-h that the user has arrived in the conference room in which the access point is located. The home broker gateway 11-h is responsible for managing the allocation of virtual machines 43. While the user is accessing the Internet, the home broker gateway 11-h obtains the location of the user device (either from location data transmitted from the mobile device 3 or from the network address of the particular sub-network 103 or access point 101 to which the mobile device 3 is connected) and prepares the virtual machine 43 of the user in accordance with the user profile data stored in the user profile data 67.

The gateway decision module 63 in the home broker gateway 11-h then uses the obtained location information to identify a server farm 9 which should host the virtual machine 43 that will provide the training session to the user. Considering, as an example mobile device A, as shown in FIG. 6, it connects to access point 101-1 located in conference room 1 and thus the home broker gateway 11 determines that the optimum server farms 9 to host the virtual machine 43 is foreign server farms 9-f1. The home broker gateway 11-h then sends a prepare virtual machine message to the foreign broker gateway 11-f1 that manages the identified server farms 9-f1. This message identifies the user and provides user profile data relating to the information provided by the user at the time of registration. The foreign broker gateway 11-f1 receives this request and sets up an appropriate virtual machine 43 on the foreign server farms 9-f1 in accordance with the user defined registration details. Once the virtual machine 43 has been setup, the foreign broker gateway 11-f1 sends a run instruction to the foreign server farms 9-f1. In response, the foreign server farms 9-f1 starts the virtual machine 43 and signals to the foreign broker gateway when it is ready. In response to receiving the ready signal, the foreign broker gateway 11-f1 sends the home broker gateway 9-h details of the server that is hosting the virtual machine 43 for the user. This ends a preparation phase for establishing the virtual machine 43 on a server farm 9 that is close to the user.

When all participants have joined a room and connected to the wireless network the training session can start. At this point, each mobile device 3 will start to make a connection to their virtual machine 43 that will provide the training. In this embodiment, they do this by sending the home broker gateway 9-h a request for the parameters for their virtual machine. In response, the home broker gateway 11-h uses the parameters provided by the respective foreign broker gateways 11-f to respond to the requests. The responses include the network address of the foreign server farms 9-f that hosts the user's virtual machine (or the network addresses of the virtual machines 43 themselves). The mobile devices 3 then use the received VM parameters to send a request to the corresponding foreign server farms 9-f to establish a connection with their virtual machine 43.

In this way, the virtual machine 43 of each user is already prepared and configured (applications, presentations, training courses, exercises etc.) and personalised for the user (level of complexity, type of training etc.). In this example it is important to note that the preparation of the virtualised environment is performed only when the user enters the room and attaches to the access point. This avoids extra resources and power consumption of the servers in the server farms 9 if, for example, a user is unable to attend the meeting for any reason.

As can be seen from FIG. 8, the system described above allows virtual machines 43 to be setup in close proximity to the user's mobile device. In this example, the virtual machines 43 can be hosted by server farms 9 that form part of the local network. This reduces the traffic over the external network (represented by the dashed lines), making the connection to the virtual machines 43 faster and more secure.

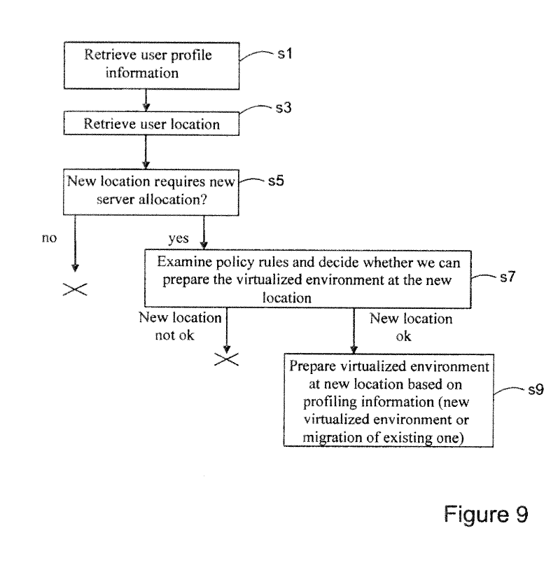

As mentioned above, the location information can be used in addition to pre-defined policy rules to provide a more optimised preparation of the virtualised environment. A flow diagram that illustrates how the home broker gateway 11-h might implement such a mechanism is illustrated in FIG. 9. As shown, in step s1, the home broker gateway 9-h retrieves the user profile information (obtained from the user at the time of registration) using the participation identifier provided by the user's mobile device 3. Then in step s3 the home broker gateway 11-h retrieves the location information for the user's mobile device 3. In step s5 the home broker device 11-h determines if the determined location requires a new server location. If a new server location is not required then the process ends. If a new server location is required, then in step s7 the home broker gateway 11-h examines its policy rules and decides whether the virtualised environment can be prepared at the new location. If the decision is no then the process ends. Otherwise, the home broker gateway 11-h prepares the virtualised environment at the new location based on the user profile information either by establishing a new virtualised environment or by migrating an existing one.

### Alternative Embodiment

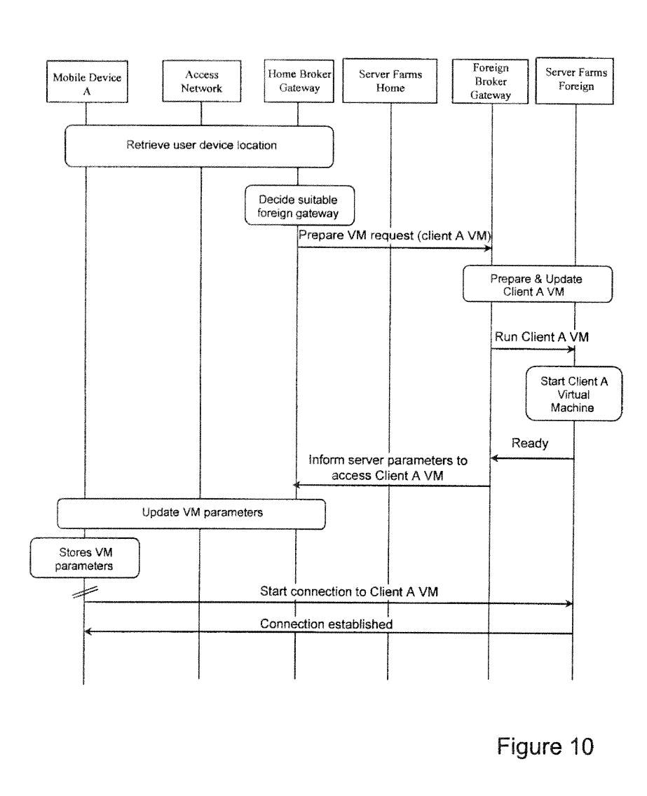

In the above embodiment, the home broker gateway 11-h obtained location information for the mobile device 3 and prepared a user's virtual machine on a server farm 9 located near to the mobile device 3. In the embodiment, the home broker gateway 11-h delivered VM parameters for the user's virtual machine when the user requests the parameters at the time that they wish to start using their virtual machine. A second embodiment will now be described in which the VM parameters are provided to the mobile device before they are requested. In this way the mobile device 3 can directly connect to the correct VM as soon as the user wishes to connect to their virtual machine. This approach speeds up the initial time required for the user's mobile device to connect with their virtual machine. The way that this embodiment works will now be described with reference to FIGS. 10 to 12.

In particular, FIG. 10 is a signal flow diagram illustrating the communications between the different devices in this embodiment. As shown, in this embodiment, the home broker gateway 11-h also actively monitors the location of the mobile device so that it can obtain the location information for the mobile device 3 without waiting for the mobile device connecting to the home broker gateway 11-h. The home broker gateway can do this by sending out information requests to the network 21 to identify the access network or the mobile network to which the mobile device is currently connected. Based on this location information, the home broker gateway 11-h decides on a suitable foreign gateway (in the same way as in the first embodiment) and sends foreign gateway a request to prepare the virtual machine for the user. The foreign gateway 11-f and the foreign server farms 9-f setup the virtual machine and then send the home broker gateway 11-h the server parameters to access the user's virtual machine. In this embodiment, when the home broker gateway 11-h receives these parameters. it sends an update message to the mobile device to cause it to update the VM parameters that it may already have for its virtual machine. The update message can be sent using Over The Air techniques such as SMS Push, or OMA Device Management method. In this way, the home broker gateway can keep the VM parameters stored on the mobile device synchronised with those stored in the home broker gateway 11-h.

Subsequently, when the user is ready to request access to their virtual machine, the mobile device 3 can use the stored VM parameters 97 to directly request connection to their virtual machine on the foreign server farm 9-f without having to connect to their home broker gateway 11-h.

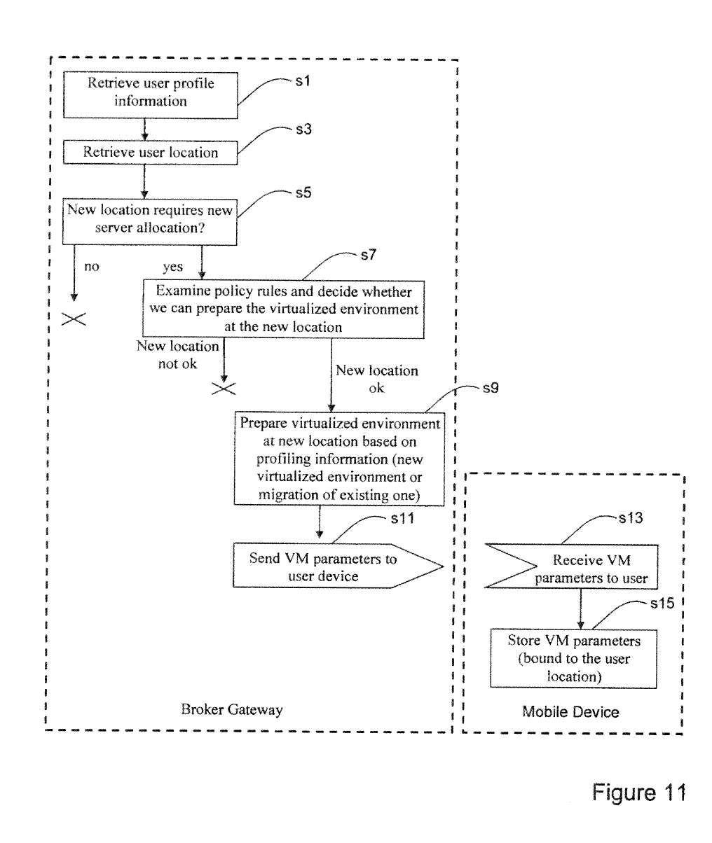

FIG. 11 is a flow diagram illustrating the way in which the home broker gateway can implement policy rules when selecting the foreign server farm 9-f on which to run the user's virtual machine. As shown in FIG. 11, the processing is the same as in the first embodiment, except after the new VM parameters have been obtained, the home broker gateway 11-h sends the VM parameters to the mobile device, in step s11, which are received by the mobile device 3 in step s13 and stored within the mobile device in step s15.

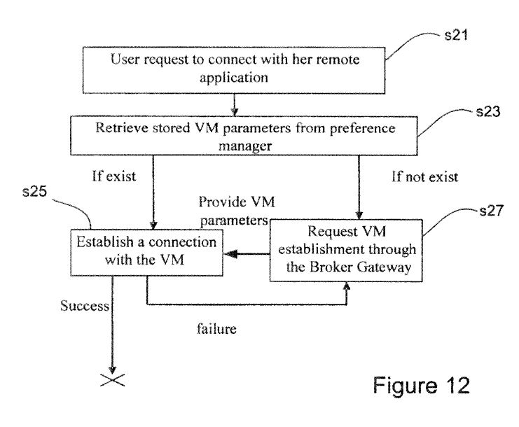

FIG. 12 is a flow chart illustrating the way in which the mobile device 3 operates in this embodiment to connect to the virtual machine. As shown, in step s21, the user operates their mobile device to request a connection with their remote application (for example, by pressing a button on the user interface of the mobile device). In response, the communications control module 95 tries to retrieve, in step s23, the stored VM parameters 97 from the memory or a preference manager that maintains such parameter information. If the parameters exist, then the communications control module 95 uses the parameters, in step s25, to try to establish a connection directly with the virtual machine. If the connection fails or if the mobile device does not have any stored VM parameters, then in step s27 the communications control module 95 requests the parameters from the home broker gateway 11-h, as in the first embodiment.

### Modifications and Alternatives

A number of detailed embodiments have been described above. As those skilled in the art will appreciate, a number of modifications and alternatives can be made to the above embodiments whilst still benefiting from the inventions embodied therein.

In the embodiments described above, the mobile device 3, broker gateways 11 and the server farms 9 each include network communications circuitry. Typically this circuitry will be formed by dedicated hardware circuits. However, in some embodiments, parts of the circuitry may be implemented as software run by the corresponding processor.

In the above embodiments, a number of software modules were described. As those skilled in the art will appreciate the software may be provided in compiled or un-compiled form and may be supplied to the mobile device 3, broker gateways 11 and the server farms 9 as a signal over a computer network, or on a recording medium. Further, the functionality performed by part or all of this software may be performed using one or more dedicated hardware circuits. However, the use of software modules is preferred as it facilitates the updating of the devices in order to update their functionalities. The functionality of one or more of the modules may be combined into a single module and in some embodiments may be built into the operating system.

Operation of the mobile device 3, broker gateways 11 and server farms 9 has been described sequentially with reference to the flow diagrams (FIGS. 7 and 9) for the purposes of clarity. It will be appreciated, however, that many of the steps need not run sequentially but may run in parallel with other steps.

It will be further appreciated that communication between the mobile device 3 and the broker gateways 11 and the server farms 9 may use any suitable wireless or wired communication protocol and associated technology. For example the respective network communication portions may be configured for communication using a Bluetooth and/or WiFi protocol in the case of radio communication, an IrDA (Infrared Data Association) protocol in the case of infrared communication and/or a Universal Serial Bus (USB) protocol in the case of wired communication. The mobile device 3, the broker gateways 11 and the server farms 9, may also be configured for long range communication via a mobile telephone network (e.g. via base station, radio network controller, core network etc) to allow long range virtualisation.

It will be appreciated that although the mobile device 3 is described as a mobile telephone (e.g. a Smartphone) it may be any suitable device for example a personal digital assistant (PDA), palmtop or notebook computer.

Various other modifications will be apparent to those skilled in the art and will not be described in further detail here.

1. A client server system comprising:
a plurality of servers distributed in a plurality of different locations, each for hosting virtual machines to be used by client devices;
a client device operable to use a virtual machine hosted on a selected one of the servers; and
a broker gateway operable to select the server that will host the virtual machine to be used by the client device;
wherein the broker gateway is operable: i) to obtain location data indicating a current location of the client device; ii) to select the server to host the virtual machine based on the obtained location data for the client device and the locations of the plurality of servers; and iii) to request establishment of a virtual machine for use by the client device on the selected server prior to the client device making a request to connect to the virtual machine.

2. A broker gateway operable to select a server that will host a virtual machine to be used by a client device; wherein the broker gateway is operable: i) to obtain location data indicating a current location of the client device; i) to select a server to host the virtual machine based on the obtained location data for the client device; and iii) to request establishment of a virtual machine for use by the client device on the selected server prior to the client device making a request to connect to the virtual machine.

3. A broker gateway according to claim 2, wherein the broker gateway includes stored data defining the location of a plurality of servers and is operable to compare the location data for the client device with the stored server location data and to select the server based on the comparison results.

4. A broker gateway according to claim 3, operable to select a server near the current location of the client device for hosting the virtual machine for the client device.

5. A broker gateway according to claim 2, wherein the broker gateway comprises user profile data and is operable to send the user profile data for the selected server for establishing the virtual machine for the client device.

6. A broker gateway according to claim 1, operable to send the client device parameters for use in connecting to the virtual machine hosted on the selected server.

7. A broker gateway according to claim 6, wherein the parameters include network address data for the virtual machine or for the selected server.

8. A broker gateway according to claim 6, which is operable to send the client device the parameters for use in connecting to the virtual machine unprompted, whenever the parameters change.

9. A broker gateway according to claim 6, which is operable to send the client device the parameters for use in connecting to the virtual machine in response to a request for the parameters received from the client device.

10. A broker gateway according to claim 2, which is operable to obtain the location data for the client device from an access network to which the client device is connected.

11. A broker gateway according to claim 10, which is operable to obtain the location data for the client device based on a network address of an access point to which the client device is currently registered or based on a network code of a cellular network to which the client device is currently registered.

12. A broker gateway according to claim 2, which is operable to obtain the location data for the client device from data transmitted from the client device.

13. A client device operable to communicate with a server and a broker gateway, wherein the client device is operable to receive parameters for a virtual machine from the broker gateway and is operable to request a connection to the virtual machine hosted by the server and wherein the client device is operable to obtain the parameters for the virtual machine prior to requesting a connection to the virtual machine.

14. A client device according to claim 13, comprising a communications control module that is operable to receive updates for the virtual machine parameter data from the broker gateway.

15. A client device according to claim 13, which is operable to request the connection to the virtual machine directly without connecting through a broker gateway.

16. A client device according to claim 13, which is operable to request updated parameters from the home broker gateway if an initial connection request to the virtual machine fails.

17. A server operable to communicate with a broker gateway and a client device, the server being operable to establish a virtual machine for use by the client device in response to a request received from the broker gateway and is operable to provide a connection between the virtual machine and the client device in response to a request for a connection received from the client device; and wherein the server is operable to establish the virtual machine for the client device prior to receiving the connection request from the client device.

18. A computer implementable instructions product comprising computer implementable instructions for causing a programmable computer device to become configured as the broker gateway of claim 2 or to become configured as a client device in which a broker gateway operable to select a server that will host a virtual machine to be used by the client device; wherein the broker gateway is operable: i) to obtain location data indicating a current location of the client device; ii) to select a server to host the virtual machine based on the obtained location data for the client device; and iii) to request establishment of a virtual machine for use by the client device on the selected server prior to the client device making a request to connect to the virtual machine which is operable to obtain the location data for the client device from data transmitted from e client device, or to become configured as a server operable to communicate with a broker gateway and a client device, the server being operable to establish a virtual machine for use by the client device in response to a request received from the broker gateway and is operable to provide a connection between the virtual machine and the client device in response to a request for a connection received from the client device; and wherein the server is operable to establish the virtual machine for the client device prior to receiving the connection request from the client device.

19. A method performed by a broker gateway, the method comprising:
obtaining location data indicating a current location of the client device;
selecting a server to host a virtual machine based on the obtained location data for the client device; and
requesting establishment of a virtual machine for use by the client device on the selected server prior to the client device making a request to connect to the virtual machine.

20. A method according to claim 19, further comprising holding data defining the location of a plurality of servers, comparing the location data for the client device with the server location data and selecting the server based on comparison results.

21. A method according to claim 20, wherein the selecting selects a server near the current location of the client device for hosting the virtual machine for the client device.

22. A method according to claim 19, further comprising holding user profile data and sending the user profile data for the selected server for establishing the virtual machine for the client device.

23. A method according to claim 19, further comprising sending the client device parameters for use in connecting to the virtual machine hosted on the selected server.

24. A method according to claim 23, wherein the parameters include network address data for the virtual machine or for the selected server.

25. A method according to claim 23, further comprising sending the client device the parameters for use in connecting to the virtual machine unprompted, whenever the parameters change.

26. A method according to claim 23, further comprising sending the client device the parameters for use in connecting to the virtual machine in response to receiving a request for the parameters from the client device.

27. A method according to claim 19, which obtains the location data for the client device from an access network to which the client device is connected.

28. A method according to claim 27, which obtains the location data for the client device based on a network address of an access point to which the client device is currently registered or based on a network code of a cellular network to which the client device is currently registered.

29. A method according to claim 19, which obtains the location data for the client device from data received from the client device.

30. A method performed by a client device that communicates with a server and a broker gateway, wherein the method comprises receiving parameters for a virtual machine from the broker gateway and requesting a connection to the virtual machine hosted by the server and wherein the receiving is performed prior to requesting the connection to the virtual machine.

31. A method according to claim 30, further comprising receiving updates for the virtual machine parameter data from the broker gateway.

32. A method according to claim 30, further comprising requesting the connection to the virtual machine directly without connecting through the home broker gateway.

33. A method according to claim 30, further comprising requesting updated parameters from the home base station if an initial connection request to the virtual machine fails.

34. A method performed by a server operable to communicate with a broker gateway and a client device, the method comprising establishing a virtual machine for use by the client device in response to a request received from the broker gateway and providing a connection between the virtual machine and the client device in response to a request for a connection received from the client device; and wherein the virtual machine is established for the client device prior to receiving the connection request from the client device.
